(19) United States
(12) Patent Application Publication
(10) Pub. No.: US 2023/0231158 A1
(43) Pub. Date: Jul. 20, 2023

(54) METHOD FOR PRODUCING A FUEL CELL, AND FUEL CELL

(71) Applicant: Robert Bosch GmbH, Stuttgart (DE)

(72) Inventors: David Thomann, Bamberg (DE); Heiko Klaumuenzer, Bamberg (DE); Marco Boehnlein, Hassfurt (DE); Robert Landvogt, Staffelstein (DE); Thomas Kretschmar, Zapfendorf (DE)

(21) Appl. No.: 18/011,205

(22) PCT Filed: Jun. 14, 2021
(86) PCT No.: PCT/EP2021/065877

§ 371 Date: Dec. 19, 2022

(30) Foreign Application Priority Data
Jun. 19, 2020 (DE) 10 2020 207 601.4

(51) Int. Cl. H01M 8/0286; H01M 8/1004; H01M 8/0273

(52) U.S. Cl. CPC H01M 8/0286; H01M 8/1004; H01M 8/0273

(57) ABSTRACT

The invention relates to a method for producing a fuel cell with a membrane electrode assembly (1), wherein at least sections thereof are surrounded by a sub-gasket (2). According to the invention, in order to form the sub-gasket (2), at least sections of the membrane electrode assembly (1) are introduced into a film sleeve (3), the film sleeve (3) is pressed together so that at least regions of two film sleeve halves lie on top of one another, and the overlapping film sleeve halves are connected, preferably adhered, to one another.

The invention also relates to a fuel cell.

### BACKGROUND OF THE INVENTION

The invention relates to a method for producing a fuel cell comprising a membrane electrode assembly which is at least partly enclosed by a sub-gasket. The invention also relates to a fuel cell which has in particular been produced according to the method according to the invention.

Fuel cells are used in both mobile and stationary applications. With their help, the chemical reaction energy of a continuously supplied fuel and an oxidizing agent can be converted into electrical energy. To increase performance, multiple fuel cells can be disposed on top of one another to form a fuel cell stack, also referred to as a “stack.”

The “heart” of a fuel cell is the so-called membrane electrode assembly (MEA), which comprises a membrane that is coated on both sides to form a first and a second catalytically active electrode. The first electrode forms the anode and the second electrode forms the cathode. The membrane in between serves as the electrolyte. During operation of the fuel cell or the fuel cell stack, the anode is supplied with a fuel, for example hydrogen. Air is supplied to the cathode as the oxidizing agent.

The MEA is typically laminated in between two thin plastic films, which together are referred to as the “sub-gasket.” They serve as electrical insulation between the anode and the cathode. Both films comprise large windows, so that the active regions of the MEA remain uncovered. The MEA is therefore enclosed by the plastic films adjoining on either side only in a peripheral edge region. The large windows and other openings are created in the plastic films in advance, specifically in each film individually, for example by means of punching. After that, the delicate structures are coated with a glue, positioned on either side of the MEA, so that the openings of the two plastic films lie exactly on top of one another, and then glued to one another. This process is tedious and time consuming, because the work has to be very precise.

The underlying object of the present invention is therefore to simplify the production of a fuel cell. The intent is in particular to achieve a higher degree of automation in the production of fuel cells, in order to make mass production more economical.

### SUMMARY OF THE INVENTION

Proposed is a method for producing a fuel cell comprising a membrane electrode assembly, which is at least partly enclosed by a sub-gasket. According to the invention, to form the sub-gasket, the membrane electrode assembly is inserted at least partly into a film sleeve, the film sleeve is pressed together so that at least some regions of the two film sleeve halves lie on top of one another and the film sleeve halves lying on top of one another are connected, preferably glued, to one another.

The proposed use of a film sleeve instead of two individual films makes it possible to simplify the formation of the sub-gasket significantly. This is because the difficult handling of two delicate individual films is eliminated. There is also no longer a need for exact alignment of the films to one another. As a result, the formation of the sub-gasket can be carried out in a very short time and also in a highly automated manner, which then enables economical mass production.

Preferably, at least one window-like opening is created in the film sleeve prior to insertion of the membrane electrode assembly in the film sleeve. The purpose of the window-like opening is to leave at least one active region of the membrane electrode assembly uncovered. Since the membrane electrode assembly forms active regions on either side, i.e., on both the anode and the cathode side, the window-like opening can be selected to be correspondingly large and the membrane electrode assembly can be inserted into the film sleeve in such a way that both active regions come to lie within this one window-like opening. In this case, the opening extends from the anode side to the cathode side of the membrane electrode assembly. Alternatively, two window-like openings can be created in the film sleeve instead of one window-like opening. The two window-like openings are preferably disposed opposite to one another. After the membrane electrode assembly is inserted and the film sleeve is pressed together, the two window-like openings therefore lie exactly on top of one another. This ensures that each one of the two active regions of the membrane electrode assembly comes to rest inside the window-like opening assigned to it.

When the membrane electrode assembly is inserted into the film sleeve, it is therefore important to ensure that the active regions configured on both sides of the membrane electrode assembly are positioned within the at least one window-like opening.

It is also possible to use two or more film sleeves instead of a single film sleeve. When two film sleeves are used, one end of the membrane electrode assembly is preferably inserted into a first film sleeve and the other end is inserted into a second film sleeve. The two film sleeves are then respectively pressed together and the respective film sleeve halves of a film sleeve lying on top of one another are connected, preferably glued, to one another. If two film sleeves are used, the formation of the at least one window-like opening in the film sleeve can be omitted. This is because, instead of the opening, the two film sleeves are simply disposed at a sufficient distance from one another for the active regions of the membrane electrode assembly to remain uncovered. The method can thus be simplified further.

When two film sleeves are used, a two-piece sub-gasket is formed. A first part surrounds a first end portion of the membrane electrode assembly, a second part surrounds a second end portion of the membrane electrode assembly. The active regions of the membrane electrode assembly respectively extend between the two end portions. In this case, the active regions are enclosed on only two sides by the two parts of the sub-gasket.

However, it is also possible to use four film sleeves to form the sub-gasket instead of two film sleeves. In this case, the two additional film sleeves are disposed offset 90° from the two first film sleeves, so that the membrane electrode assembly is enclosed all the way around and the active regions are left uncovered.

If only one film sleeve is used, in order to leave the active regions of the membrane electrode assembly uncovered, it is preferable to use a film sleeve comprising at least two window-like openings. The membrane electrode assembly is thus enclosed all the way around, while the active regions on both sides of the membrane electrode assembly remain uncovered. Enclosing the membrane electrode assembly all the way around, also creates an all-around reinforcement of the edge.

The membrane electrode assembly is preferably inserted fully into the film sleeve, so that a respective film sleeve end extends beyond the membrane electrode assembly on either side. Then when the film sleeve is pressed together, two respective film sleeve halves lie on top of one another in the region of the projecting film sleeve ends and can easily be connected, preferably glued, to one another.

In order to achieve bonding of two film sleeve halves lying on top of one another as soon as the film sleeve is pressed together, it is proposed that the inside of the film sleeve be coated with a glue prior to insertion of the membrane electrode assembly in the film sleeve. The method steps pressing together and connecting or gluing can thus be carried out in one work step, which saves even more time.

After the method steps:
inserting the membrane electrode assembly into the film sleeve,
pressing the film sleeve together and
connecting the film sleeve halves lying on top of one another,
   at least one supply opening is preferably created in two film sleeve halves lying on top of one another. The supply opening serves to form a supply channel when a plurality of the same type of fuel cells are disposed on top of one another to produce a fuel cell stack. Since typically multiple supply channels are required, it is proposed that multiple supply openings be created in two film sleeve halves lying on top of one another.

By creating the at least one supply opening in the film sleeve halves lying on top of one another later, it is not necessary to ensure that the supply openings lie exactly on top of one another when the membrane electrode assembly is inserted into the film sleeve and/or when the film sleeve is subsequently pressed together, because there are no supply openings yet.

The at least one window-like opening and/or the at least one supply opening is/are advantageously created in a punching process. Punching allows openings to be produced easily and cost-efficiently. Templates can furthermore be produced, which simplify mass production.

Also proposed is a fuel cell comprising a membrane electrode assembly, which is at least partly enclosed by a sub-gasket. According to the invention, the sub-gasket is made of at least one film sleeve. This means that the sub-gasket forms a fold along each of two side edges, which preferably extend substantially parallel. This is because there are not two individual foils lying on top of one another, but two film sleeve halves.

The proposed fuel cell can therefore in particular be produced according to the above-described method according to the invention. This means that the proposed fuel cell can be produced comparatively easily and cost-efficiently. It is in particular possible to achieve a high degree of automation in the production of the fuel cell, so that it is suitable for mass production.

In a further development of the invention, it is proposed that the film sleeve comprise two film sleeve halves, at least some regions of which lie on top of one another and which are connected, preferably glued, to one another. Connecting or gluing the film sleeve halves fixes said halves both to one another and with respect to the membrane electrode assembly.

### BRIEF DESCRIPTION OF THE DRAWINGS

The invention will be explained in more detail in the following with reference to the accompanying drawings. The figures show:

FIG. 1 a simple perspective view of a membrane electrode assembly comprising a film sleeve for producing a fuel cell according to the invention,

FIG. 2 a simple perspective view of a membrane electrode assembly comprising two film sleeves for producing a fuel cell according to the invention,

FIG. 3 a simple perspective view of a membrane electrode assembly comprising a sub-gasket for producing a fuel cell according to the invention and

FIG. 4 a simple perspective view of a membrane electrode assembly comprising two individual foils for producing of a fuel cell known from the prior art.

### DETAILED DESCRIPTION

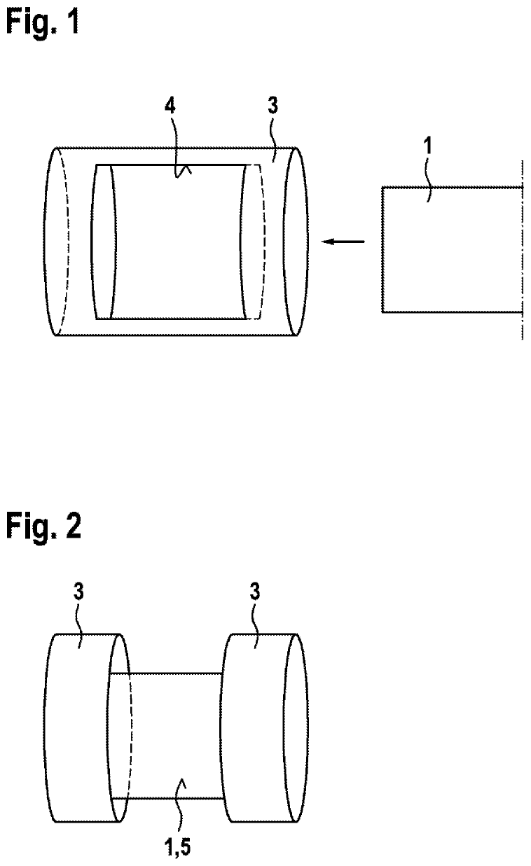

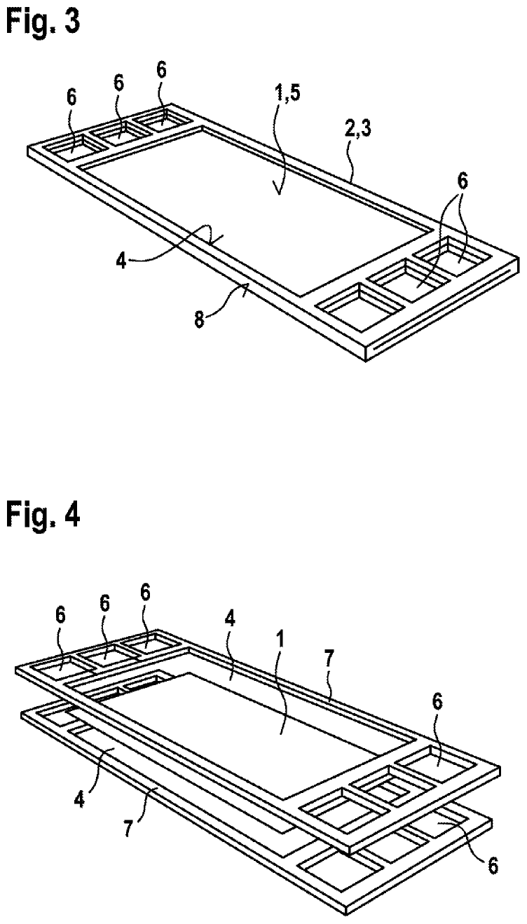

The highly simplified illustration of FIG. 1 shows a membrane electrode assembly 1 and a film sleeve 3 for producing a fuel cell. The membrane electrode assembly 1 comprises a membrane which is coated on both sides with a catalytically active material, not shown in further detail in FIG. 1, to form electrodes. To form a sub-gasket 2 (see FIG. 3), the membrane electrode assembly 1 is inserted into the film sleeve 3, the film sleeve 3 is pressed together and the film sleeve halves lying on top of one another are connected, preferably glued, to one another. In the region of two window-like openings 4 of the film sleeve 3, active regions 5 of the membrane electrode assembly 1 remain uncovered (see FIG. 3). To form supply openings 6 (see FIG. 3), punched out sections are subsequently provided in the film sleeve halves which lie on top of one another and are connected, preferably glued, to one another. Thus, the membrane electrode assembly 1 of FIG. 3 enclosed by the sub-gasket 2 is obtained.

In contrast to the use of two individual foils 7 known in the prior art (see FIG. 4), no delicate lattice-like structures have to be positioned exactly and placed on top of one another. The use of one film sleeve 3 can therefore significantly simplify the production of a fuel cell. Unlike the use of two individual foils 7, a sub-gasket 2 made from one film sleeve 3 forms a fold 8 along each of two side edges (see FIG. 3).

It is also possible to use two film sleeves 3 instead of a single film sleeve 3. One respective end portion of the membrane electrode assembly 1 is then inserted into one film sleeve 3. This embodiment is shown as an example in FIG. 2. Here, too, the active regions 5 of the membrane electrode assembly 1 remain uncovered, because the two film sleeves 3 each enclose only one end portion of the membrane electrode assembly 1. This embodiment has the advantage that no window-like opening 4 has to be created in the film sleeve 3.

1. A method for producing a fuel cell comprising a membrane electrode assembly (1), which is at least partly enclosed by a sub-gasket (2), the method comprising the following steps: to form the sub-gasket (2), the membrane electrode assembly (1) is inserted at least partly into a film sleeve (3), thereafter the film sleeve (3) is pressed together so that at least some regions of two halves of the film sleeve lie on top of one another, and thereafter the film sleeve halves lying on top of one another are connected to one another.

2. The method according to claim 1, characterized in that, prior to insertion of the membrane electrode assembly (1) into the film sleeve (3), at least one window-like opening (4) is created in the film sleeve (3).

3. The method according to claim 2, characterized in that, when the membrane electrode assembly (1) is inserted into the film sleeve (3), active regions (5) configured on both sides of the membrane electrode assembly (1) are positioned within the at least one window-like opening (4).

4. The method according to claim 1, characterized in that one end of the membrane electrode assembly (1) is inserted into a first film sleeve (3) and an other end of the membrane electrode assembly (1) is inserted into a second film sleeve (3), the first and second film sleeves (3) are respectively pressed together and respective film sleeve halves of the first and second film sleeves lying on top of one another are connected to one another.

5. The method according to claim 1, characterized in that the membrane electrode assembly (1) is inserted fully into the film sleeve (3), so that a respective film sleeve end extends beyond the membrane electrode assembly (1) on either side.

6. The method according to claim 1, characterized in that, prior to insertion of the membrane electrode assembly (1) into the film sleeve (3), the inside of the film sleeve (3) is coated with a glue.

7. The method according to claim 1, characterized in that, after the membrane electrode assembly (1) is inserted into the film sleeve (3), the film sleeve (3) is pressed together and halves of the film sleeve lying on top of one another are connected, and at least one supply opening (6) is created in the two film sleeve halves lying on top of one another.

8. The method according to claim 2, characterized in that the at least one window-like opening (4) is created in a punching process.

9. A fuel cell comprising a membrane electrode assembly (1), which is at least partly enclosed by a sub-gasket (2), characterized in that the sub-gasket (2) is made of at least one film sleeve (3).

10. The fuel cell according to claim 9, characterized in that the film sleeve (3) comprises two film sleeve halves, at least some regions of which lie on top of one another and which are connected to one another.

11. The method according to claim 1, wherein the film sleeve halves lying on top of one another are glued to one another.

12. The method according to claim 11, characterized in that, prior to insertion of the membrane electrode assembly (1) into the film sleeve (3), two window-like openings (4) are created in the film sleeve (3), wherein the two window-like openings (4) are disposed opposite to one another.

13. The method according to claim 12, characterized in that, when the membrane electrode assembly (1) is inserted into the film sleeve (3), active regions (5) configured on both sides of the membrane electrode assembly (1) are positioned within the at least one window-like opening (4).

14. The method according to claim 11, characterized in that one end of the membrane electrode assembly (1) is inserted into a first film sleeve (3) and an other end of the membrane electrode assembly (1) is inserted into a second film sleeve (3), the first and second film sleeves (3) are respectively pressed together and respective film sleeve halves of the first and second film sleeves lying on top of one another are glued to one another.

15. The method according to claim 7, characterized in that the at least one supply opening (6) is created in a punching process.

16. The method according to claim 2, characterized in that, after the membrane electrode assembly (1) is inserted into the film sleeve (3), the film sleeve (3) is pressed together and halves of the film sleeve lying on top of one another are connected, and at least one supply opening (6) is created in the two film sleeve halves lying on top of one another.

17. The method according to claim 16, characterized in that the at least one window-like opening (4) and the at least one supply opening (6) are created in a punching process.

18. The fuel cell according to claim 9, characterized in that the film sleeve (3) comprises two film sleeve halves, at least some regions of which lie on top of one another and which are glued to one another.
